(19) United States
(12) Patent Application Publication
(10) Pub. No.: US 2007/0056205 A1
(43) Pub. Date: Mar. 15, 2007

(54) FISHING HOOK RETAINING APPARATUS AND METHOD

(76) Inventor: William W. Adams, Phoenix, AZ (US)

Correspondence Address: WEISS & MOY PC, 4204 NORTH BROWN AVENUE, SCOTTSDALE, AZ, 85251, US

(21) Appl. No.: 11/555,956

(22) Filed: Nov. 2, 2006

Related U.S. Application Data
(63) Continuation-in-part of application No. 11/151,039, filed on Jun. 13, 2005, now Pat. No. 7,152,359.

(51) Int. Cl. A01K 97/06

(52) U.S. Cl. 43/25.2; 43/57.1

(57) ABSTRACT

A fishing hook retaining apparatus and method, utilizing a retaining apparatus secured to a shaft of a fishing pole. The apparatus comprises two upwardly angled opposing sides, with a bar interposed therebetween. The bar may be a magnet. The apparatus may also have magnets coupled to the inner surfaces of the opposing sides. In another embodiment, the apparatus is integral with the shaft of the pole.

### CROSS-REFERENCE TO RELATED APPLICATION

This is a continuation-in-part of U.S. patent application Ser. No. 11/151,039 filed Jun. 13, 2005 in the name of the Applicant, to which priority is claimed.

### FIELD OF THE INVENTION

The present invention relates to apparatuses and methods for retaining fishing hooks and, more particularly, to embodiments of fishing hook retaining apparatuses and methods that permit the retention of a hook while protecting a fly or single point/barb hook located thereon.

### BACKGROUND OF THE INVENTION

A common problem encountered by fishermen of all skill levels relates to the storage of hooks on fishing poles. There is a need for a convenient means for storing hooks that are not being used, whether on a long-term basis between fishing outings, or during a particular fishing outing when a different hook is being utilized or during a break in fishing. Storage, to be effective and safe, should secure the hook in a place where neither its barb nor point is at significant risk of coming into contact with the hand or other body portion of the fisherman or bystander.

In the area of fly fishing, the problem is made more complicated by the fact that care needs to be taken to not damage a fly during the storage of a hook that is still coupled to a fly. Flies can be delicate and expensive, and the mishandling of a fly can harm it and reduce its effectiveness.

There is a need therefore for a fishing hook retaining apparatus and method that facilitates the storage of a hook when not in use, in a manner that is protective of the fly. The present invention satisfies these needs and provides other, related, advantages.

### SUMMARY OF THE INVENTION

In accordance with one embodiment of the present invention, a fishing hook retaining apparatus is provided. The apparatus comprises, in combination: a base; means for securing the base to a fishing pole shaft; opposing sides projecting upward at a substantially ninety degree angle from the base; a bar interposed between the opposing sides; wherein the opposing sides are angled from a first end to a second end thereof, so that the bar is coupled at substantially the highest point of opposing sides.

In accordance with another embodiment of the present invention, fishing hook retaining apparatus is provided. The apparatus comprises, in combination: a base having a front end and a rear end and wherein an underside of the base is shaped to conform to a fishing pole shaft; at least a first ring coupled over the front end of the base and about the fishing pole shaft; at least a second ring coupled over the rear end of the base and about the fishing pole shaft; opposing sides projecting upward at a substantially ninety degree angle from the base; and a magnetic bar interposed between the opposing sides; wherein the opposing sides are angled from a first end to a second end thereof, so that the bar is coupled at substantially the highest point of opposing sides; and wherein the base extends beyond a front end of the opposing sides and beyond a rear end of the opposing sides.

In accordance with a further embodiment of the present invention, a method for retaining a fishing hook is provided. The method comprises: providing a fishing hook retaining apparatus, the fishing hook retaining apparatus comprising, in combination: a base; means for securing the base to a shaft of a fishing pole; opposing sides projecting upward at a substantially ninety degree angle from the base; and a magnetic bar interposed between the opposing sides; wherein the opposing sides are angled from a first end to a second end thereof, so that the bar is coupled at substantially the highest point of opposing sides; and hooking a fish hook about the magnetic bar so that a barb and a point of the fish hook are inside the apparatus.

### BRIEF DESCRIPTION OF THE DRAWINGS

FIG. 1 is a perspective view of a fishing hook retaining apparatus consistent with an embodiment of the present invention.

FIG. 2 is a top view of the fishing hook retaining apparatus of FIG. 1.

FIG. 3 is a bottom view of the fishing hook retaining apparatus of FIG. 1.

FIG. 4 is a side, cross-sectional view of the fishing hook retaining apparatus of FIG. 1.

FIG. 5 is a front view of the fishing hook retaining apparatus of FIG. 1.

FIG. 6 is a rear view of the fishing hook retaining apparatus of FIG. 1.

FIG. 7 is a first side view of the fishing hook retaining apparatus of FIG. 1.

FIG. 8 is a second side view of the fishing hook retaining apparatus of FIG. 1.

FIG. 9 is a perspective view of the fishing hook retaining apparatus of FIG. 1, with a hook therein and in position on a shaft of a fishing pole.

FIG. 10 is a front view of the fishing hook retaining apparatus of FIG. 1, with a hook therein and in position on a shaft of a fishing pole.

FIG. 11 is a front view of a fishing hook retaining apparatus, consistent with another embodiment of the present invention.

FIG. 12 is a rear view of the fishing hook retaining apparatus of FIG. 11.

FIG. 13 is a top view of a fishing hook retaining apparatus, consistent with another embodiment of the present invention.

FIG. 14 is a side view of the fishing hook retaining apparatus of FIG. 13.

FIG. 15 is a side, cross-sectional view of a fishing hook retaining apparatus, consistent with another embodiment of the present invention.

FIG. 16 is a side view of the fishing hook retaining apparatus of FIG. 15.

FIG. 17 is a top view of the fishing hook retaining apparatus of FIG. 15.

FIG. 18 is a front view of the fishing hook retaining apparatus of FIG. 15.

FIG. 19 is a front view of a fishing hook retaining apparatus consistent with another embodiment of the present invention.

FIG. 20 is a rear view of the fishing hook retaining apparatus of FIG. 19.

FIG. 21 is a top view a fishing hook retaining apparatus consistent with another embodiment of the present invention.

FIG. 22 is a cross-sectional side view of the fishing hook retaining apparatus of FIG. 21.

FIG. 23 is a side, cross-sectional view of a fishing hook retaining apparatus, consistent with another embodiment of the present invention, shown with a magnet coupled to an inner surface of one of the opposing sides of the apparatus.

FIG. 24 is a top view of the fishing hook retaining apparatus of FIG. 23 shown coupled to the fishing pole with at least two rings and shown with two magnets coupled to the inner surfaces of the opposing sides of the apparatus.

FIG. 25 is a front view of the fishing hook retaining apparatus of FIG. 23.

### DETAILED DESCRIPTION OF THE PREFERRED EMBODIMENTS

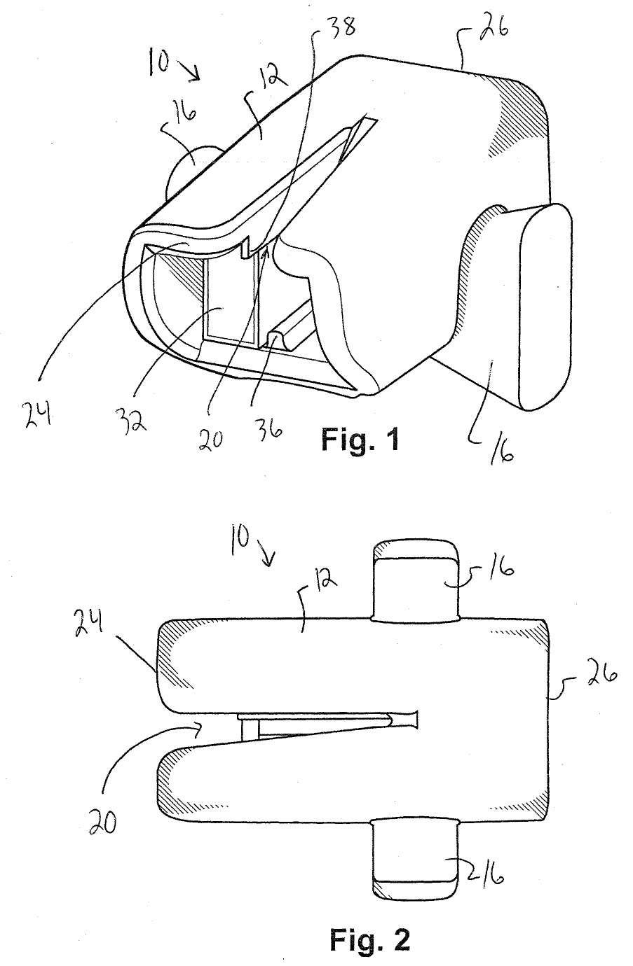

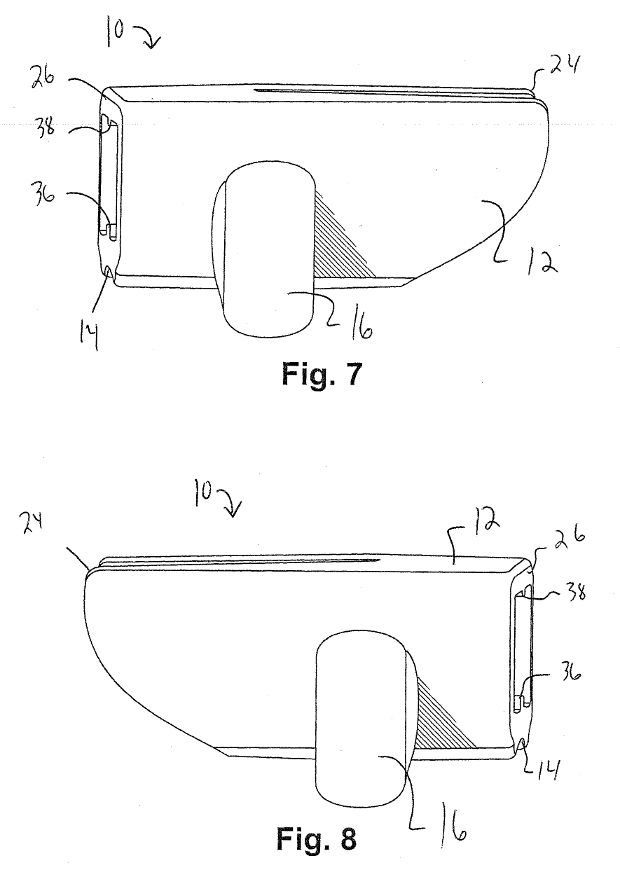

Referring first to FIGS. 1-10, a fishing hook retaining apparatus 10 (“apparatus 10”) consistent with an embodiment of the present invention is shown. In this embodiment, the apparatus 10 defines a sleeve 12. The underside 14 of the sleeve 12 is preferably shaped to conform to a fishing pole shaft 15. Projecting from each side of sleeve 12, substantially perpendicular thereto, may be securing members 16.

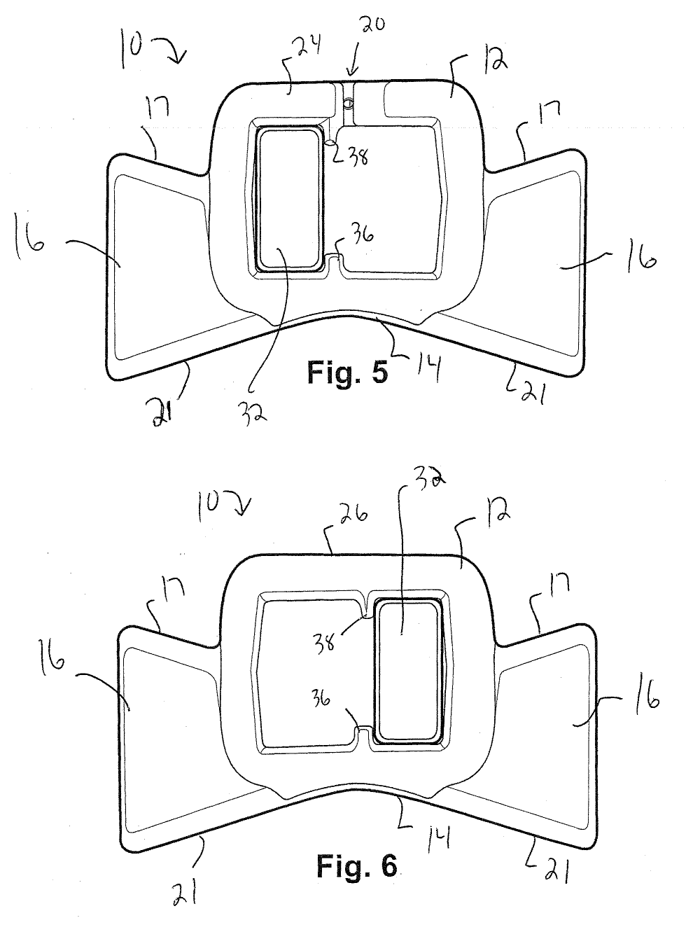

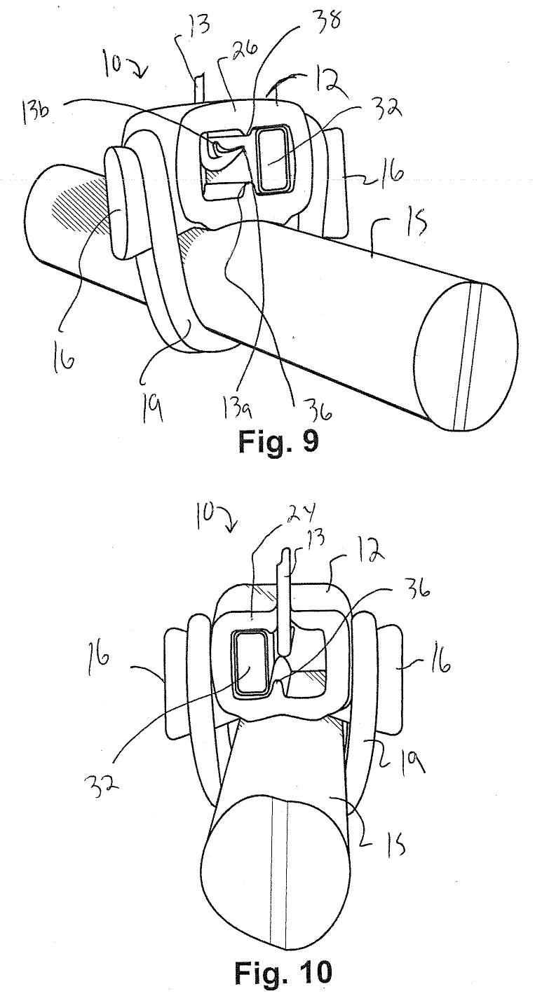

As best seen in FIGS. 5-6, an upper surface 17 of each securing member 16 is preferably angled in an upward direction outward from the sleeve 12. The upward angling of the upper surface 17 is intended to facilitate, as described in more detail below, the securing of the apparatus 10 to the shaft 15 with an O-ring 19 (see FIGS. 9-10) or other fastener. As also seen in these drawing figures, a lower surface 21 of the securing member is preferably angled in a downward direction outward from the sleeve 12. The downward angling of the lower surface 21 is intended to further conform the lower surface generally of the apparatus 10 to the shape of the shaft 15 to which the apparatus 10 is being secured. It should be noted that where sufficient gripping force can be achieved with a particular 0-ring or other fastener, it may be unnecessary to provide an upward angling of the upper surface 17, and/or to provide a downward angling of the lower surface 21.

It is preferred to provide a channel 20 in an upper surface of the sleeve 12, extending from a front edge 24 of sleeve 12 part of the distance toward rear edge 26 of the sleeve 12. Preferably, as shown in FIGS. 1, 2, 4, and 7-8, the channel 20 terminates before the rear edge 26, so that, as will be described more fully below, it will not be possible to pull a hook 13 all of the way through sleeve 12. As best seen in FIGS. 1-2, it is preferred that channel 20 have a substantially V-shape, so that the channel 20 narrows from its opening to its close. This tends to promote the positioning of the hook 13 relative to the magnet 32, as herein described in greater detail below, while also making insertion of the hook 13 into the channel 20 relatively easier for the user.

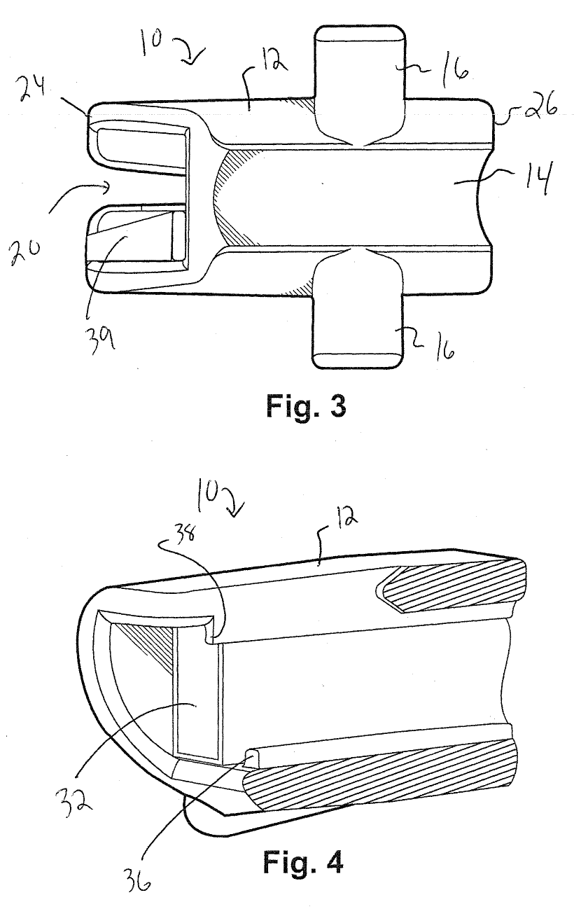

Turning now to a description of the interior of the sleeve 12, it is preferred that the interior be divided into a first side and a second side. Preferably, the first side is utilized to secure at least one magnet 32 therein. The second side is utilized to permit the insertion of some portion of a hook 13 therein, including, preferably, the hook point 13a and barb 13b. To facilitate a clear division of the interior of the sleeve 12 as herein described, and to promote ready securing of the magnet 32 in the first side, it may be desired to provide an upward projecting ridge 36 along a bottom interior length of the sleeve 12, and a downward projecting ridge 38 along a top interior length of the sleeve 12. As best seen in FIGS. 4-6 and 9-10, the magnet 32 may be secured in the first side by inserting it therein, so that a first side of the magnet 32 contacts an interior side of the sleeve 12, and a second side of the magnet 32 contacts each of ridges 36 and 38. It may be sufficient to press fit a magnet 32 into position, or it may be preferred to provide glue or other securing means to more securely retain it into position for use. As shown by way of example in FIG. 3, in one embodiment, it may be desired to provide a molded, angled portion 39 proximate the opening of the sleeve 12, against which an end of the magnet 32 would abut. This would further facilitate insertion of the hook 13 by facilitating its entry into the sleeve 12, and would prevent the hook 13 from being magnetically coupled to the magnet 32 until the hook 13 is in position within the interior of the sleeve 12.

It is preferred that the apparatus 10, other than the magnet 32, be a one-piece assembly. In particular, it is preferred that it be formed from a single piece of molded plastic, though other materials may be substituted as desired.

It should be noted that it may be desired to provide an apparatus having substantially the features of apparatus 10, without providing a magnet 32 therein. In such a configuration, securing of the hook 13 would be accomplished by, for example, the placement of tension on fishing line coupled between the hook 13 and a fishing reel.

It should be noted that one or more than one apparatuses 10 may be positioned along a shaft 15, as desired. The apparatuses 10 may be positioned above the shaft or below the shaft, proximate the handgrip or remote from it—as desired.

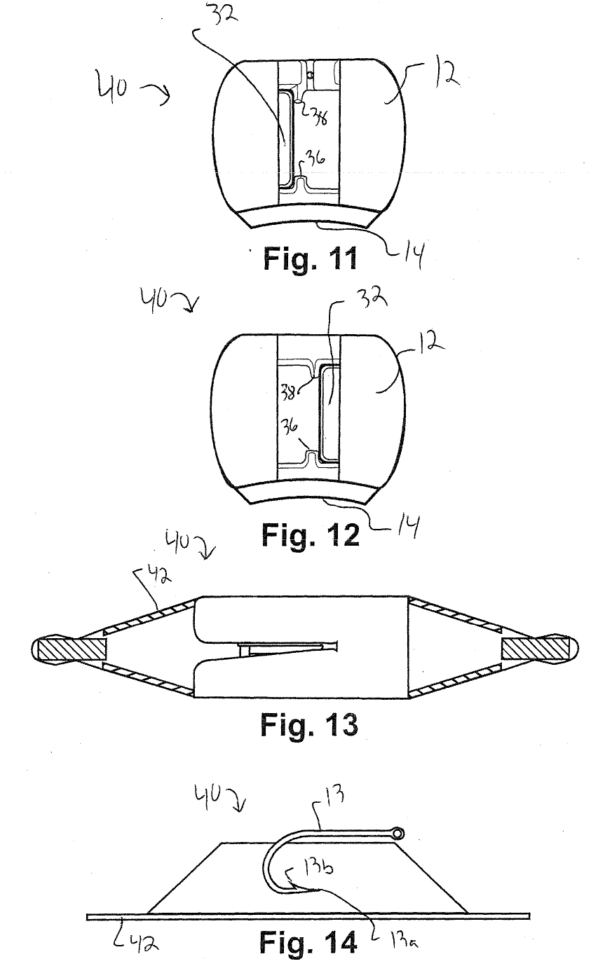

Referring now to FIGS. 11-14, a fishing hook retaining apparatus 40 (“apparatus 40”) consistent with another embodiment of the present invention is shown. In this embodiment, the apparatus 40 preferably comprises many of the features identified above with respect to the embodiment of FIGS. 1-10, which are shown in FIGS. 11-14 using the same reference numbers as used above. The embodiment of FIGS. 11-14 is distinguished from the embodiment of FIGS. 1-10 by the elimination of the outwardly projecting securing members 16. In their stead, coupling of the apparatus 40 is accomplished by other means. For example, as shown in FIG. 13, a base 42 may be provided, extending beyond a front and rear end of the apparatus 40, which base 42 may be coupled to a fishing pole shaft (not shown) by any desired means, such as the retention of ends of the base 42 below a ring or other grasping means, the gluing of the base 42 to the fishing pole shaft, or otherwise. The ends of the base 42 may also be attached to the fishing pole shaft 15 by nylon thread or other thin string-like material wrapped thereabout and then covered with epoxy/glue.

The advantage of apparatus 40 as compared to apparatus 10 is the elimination of the O-ring, and the provision of a more permanent, more secure connection between the apparatus and the fishing pole shaft that does not require securing members 16. Other than with respect to the coupling thereof to the fishing pole shaft, the apparatus 40 functions like the apparatus 10 with respect to the insertion and storage of hooks therein.

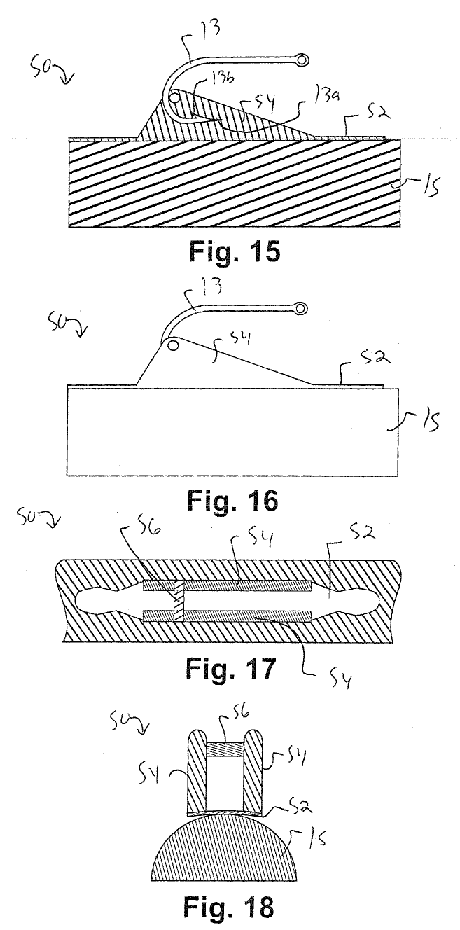

Referring now to FIGS. 15-18, a fishing hook retaining apparatus 50 (“apparatus 50”) consistent with another embodiment of the present invention is shown. In this embodiment, the apparatus 50 preferably comprises a base 52, opposing sides 54 projecting upward at a substantially ninety degree angle from the base 52, and a bar 56 interposed between the opposing sides 54.

As best seen in FIGS. 15-16, it is preferred that the opposing sides 54 be angled from a first end to a second end thereof, so that the bar 56 is coupled proximate the highest point of opposing sides 54. This permits ready insertion of the hook 13, with the point 13a clearing the shaft 15 when in position. As noted above with respect to the base 42 of the embodiment of FIGS. 10-14, the base 52 may be coupled to a fishing pole shaft 15 by any desired means, such as the retention of ends of the base 52 below a ring or other grasping means, the gluing of the base 52 to the fishing pole shaft, or otherwise.

The apparatus 50 may be positioned along the shaft 15 as desired. In one embodiment, the apparatus 50 may be positioned proximate the handgrip, in the region where a keeper or guide ring might otherwise be located.

The size of the apparatus 50 components can be varied as desired, taking into account the size of the hook 13 and/or shaft 15 with which it is to be used. A width of about 0.3″ would be satisfactory for many uses, and a length of a top portion thereof of about 0.6″ would similarly be suitable for certain uses. However, these dimensions can be varied.

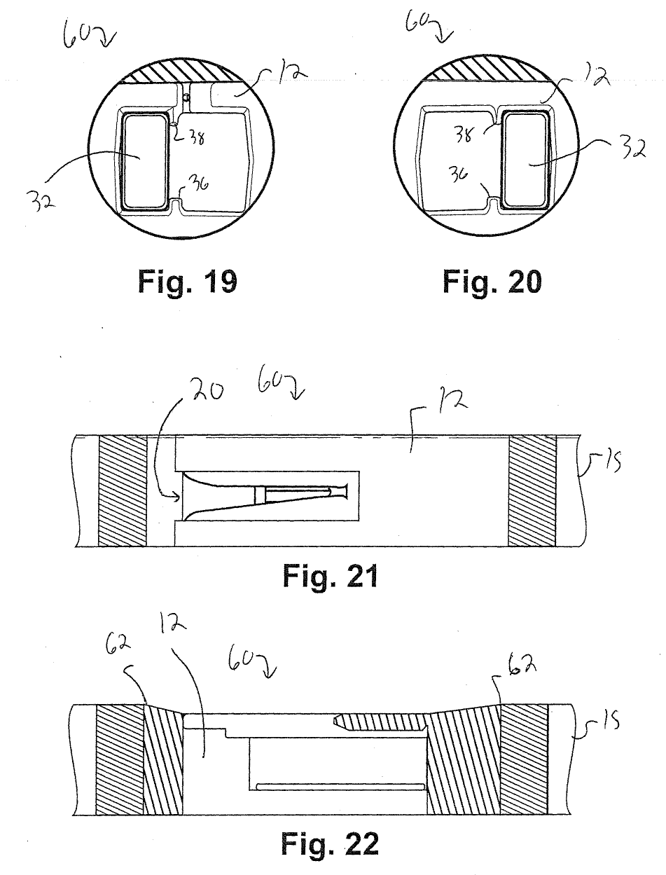

Referring now to FIGS. 19-22, a fishing hook retaining apparatus 60 (“apparatus 60”) consistent with another embodiment of the present invention is shown. In this embodiment, the apparatus 60 preferably comprises many of the features identified above with respect to the embodiment of FIGS. 1-10, which are shown in FIGS. 19-22 using the same reference numbers as used above. The embodiment of FIGS. 19-22 is distinguished from the embodiment of FIGS. 1-10 by the elimination of the outwardly projecting securing members 16, and the integration of the apparatus 60 into the shaft 15. In this manner, the apparatus 60 will not protrude, or at least the amount of protrusion can be reduced, as compared to the apparatuses 10, 40 and 50 described above. This can serve to limit any interference that the apparatus 60 might otherwise cause with fishing activities. As best seen in FIG. 22, it may be desired to slightly recess a top portion of the sleeve 12, creating a slight stop 62 at either or both ends thereof, to further reduce the profile thereof.

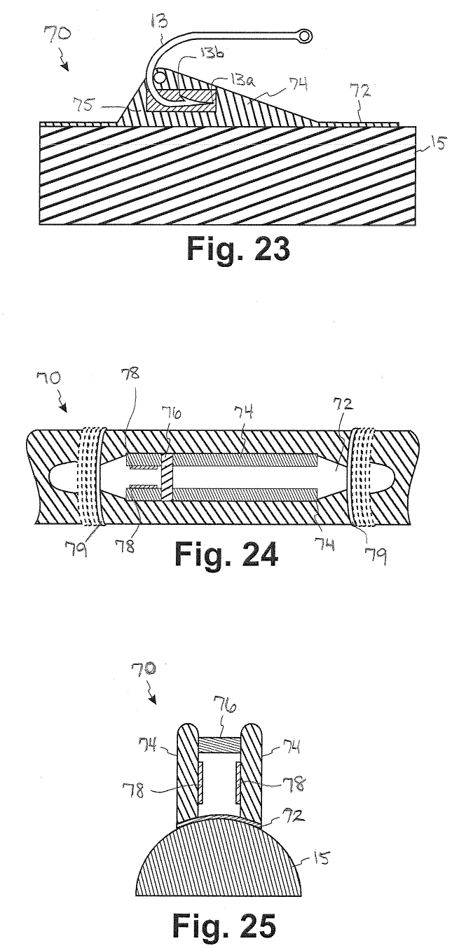

Referring now to FIGS. 23-25, a fishing hook retaining apparatus 70 (“apparatus 70”) consistent with another embodiment of the present invention is shown. Similar to the embodiment shown in FIGS. 15-18, in this embodiment, the apparatus 70 preferably comprises a base 72, opposing sides 74 projecting upward at a substantially ninety degree angle from the base 72, and a bar 76 interposed between the opposing sides 74. The bar 76 may be a magnet, but it should be clearly understood that substantial benefit may be derived from a bar 76 that is not a magnet. The fish hook retaining apparatus 70 may also have a magnet 78 coupled to an inner surface 75 of one or both of the opposing sides 74. It should be clearly understood that substantial benefit may be derived from the fishing hook retaining apparatus 70 having magnets 78 on the inner surfaces instead of or in addition to having a magnetic bar 76. It should also be clearly understood that while the magnets 78 are shown to be rectangular in shape, substantial benefit may be derived from the magnets 78 being in any shape.

As best seen in FIG. 23, it is preferred that the opposing sides 74 be angled from a first end to a second end thereof, so that the bar 76 is coupled proximate the highest point of opposing sides 74. This permits ready insertion of the hook 13, with the point 13a clearing the shaft 15 when in position. The base 72 may be coupled to a fishing pole shaft 15 by any desired means, such as the retention of ends of the base 72 below a ring 79 or other grasping means, the gluing of the base 72 to the fishing pole shaft 15, or otherwise. The base 72 may extend beyond a front end of the opposing sides 74 and beyond a rear end of the opposing sides 74. A first ring 79 may then be passed over a front end of the base 72 and about the fishing pole shaft 15 and a second ring 79 may be passed over a rear end of the base 72 and about the fishing pole shaft 15. As shown in FIG. 24, each end of the base 72 may be coupled to the fishing pole shaft 15 by one ring 79 or by a plurality of rings 79. The ends of the base 72 may also be attached to the fishing pole shaft 15 by a length of material, such as nylon thread or other thin string-like material, wrapped thereabout and then covered with epoxy/glue.

The size of the apparatus 10, 40, 50, 60 and/or 70 components can be varied as desired, taking into account the size of the hook 13 and/or shaft 15 with which it is to be used. A width for the sleeve 12 of between about 0.25 and 0.5″ would be satisfactory for many uses, and a length of the sleeve 12 of about 0.6″ would similarly be suitable for certain uses. A sleeve height of between about 0.2 and 0.25″ would similarly be suitable for certain uses. However, these dimensions can be varied as desired without departing from the spirit or scope of the present invention.

It should be understood that the invention is not necessarily limited to the specific arrangement, materials and components shown and described above, but may be susceptible to numerous variations within the scope of the invention. It will be understood that the above description of the preferred embodiments of the present invention are susceptible to various modifications, changes and adaptations, and the same are intended to be comprehended within the meaning and range of equivalents of the appended claims.

I claim:

1. A fishing hook retaining apparatus comprising, in combination:
a base;
means for securing the base to a fishing pole shaft;
opposing sides projecting upward at a substantially ninety degree angle from the base;
a bar interposed between the opposing sides;
wherein the opposing sides are angled from a first end to a second end thereof, so that the bar is coupled at substantially the highest point of opposing sides.

2. The apparatus of claim 1 wherein the base extends beyond a front end of the opposing sides and beyond a rear end of the opposing sides.

3. The apparatus of claim 1 wherein the securing means comprises at least one ring coupled over the apparatus and about the fishing pole shaft.

4. The apparatus of claim 2 wherein the securing means comprises:
at least a first ring coupled over a front end of the base and about the fishing pole shaft; and
at least a second ring coupled over a rear end of the base and about the fishing pole shaft.

5. The apparatus of claim 1 wherein the bar is a magnet.

6. The apparatus of claim 5 further comprising at least one magnet coupled to an inner surface of at least one of the opposing sides.

7. The apparatus of claim 6 wherein each component thereof, other than the bar and the at least one magnet coupled to an inner surface of at least one of the opposing sides, is formed from a single piece of molded plastic.

8. The apparatus of claim 1 further comprising at least one magnet coupled to an inner surface of at least one of the opposing sides.

9. The apparatus of claim 8 wherein each component thereof, other than the at least one magnet coupled to an inner surface of at least one of the opposing sides, is formed from a single piece of molded plastic.

10. The apparatus of claim 1 wherein the base is coupled to the fishing pole shaft by retention of two ends of the base below a plurality of rings coupled about the fishing pole shaft.

11. The apparatus of claim 1 wherein the base is coupled to the fishing pole shaft by retention of two ends of the base below a length of material wrapped thereabout.

12. The apparatus of claim 1 wherein the base is coupled to the fishing pole shaft with an adhesive.

13. The apparatus of claim 1 wherein the base is integral to the fishing pole shaft.

14. The apparatus of claim 1 wherein an underside of the base is wherein an underside of the sleeve is shaped to conform to the shaft of the fishing pole.

15. The apparatus of claim 1 wherein the apparatus is positioned proximate a handgrip of the fishing pole.

16. A fishing hook retaining apparatus comprising, in combination:
a base having a front end and a rear end and wherein an underside of the base is shaped to conform to a fishing pole shaft;
at least a first ring coupled over the front end of the base and about the fishing pole shaft;
at least a second ring coupled over the rear end of the base and about the fishing pole shaft;
opposing sides projecting upward at a substantially ninety degree angle from the base; and
a magnetic bar interposed between the opposing sides;
wherein the opposing sides are angled from a first end to a second end thereof, so that the bar is coupled at substantially the highest point of opposing sides; and
wherein the base extends beyond a front end of the opposing sides and beyond a rear end of the opposing sides.

17. The apparatus of claim 16 further comprising at least one magnet coupled to an inner surface of at least one of the opposing sides.

18. The apparatus of claim 16 the base is coupled to the fishing pole shaft by retention of two ends of the base below a plurality of rings coupled about the fishing pole shaft.

19. A method for storing a fishing hook comprising:
providing a fishing hook retaining apparatus, the fishing hook retaining apparatus comprising, in combination:
a base;
means for securing the base to a shaft of a fishing pole;
opposing sides projecting upward at a substantially ninety degree angle from the base; and
a magnetic bar interposed between the opposing sides;
wherein the opposing sides are angled from a first end to a second end thereof, so that the bar is coupled at substantially the highest point of opposing sides; and
hooking a fish hook about the magnetic bar so that a barb and a point of the fish hook are inside the apparatus.

20. The method of claim 19 further comprising the step of providing at least one magnet coupled to an inner surface of at least one of the opposing sides, wherein the fish hook is brought into contact with the at least one magnet coupled to an inner surface of at least one of the opposing sides and secured thereto.
